(19) United States
(12) Patent Application Publication
(10) Pub. No.: US 2001/0031382 A1
(43) Pub. Date: Oct. 18, 2001

(54) Magnetic recording medium and method for improving wettability of a protective film of the magnetic recording medium

(76) Inventors: Kazuhiro Kusakawa, Nagano (JP); Michinari Kamiyama, Nagano (JP); Masaki Miyazato, Nagano (JP); Masanori Yoshihara, Nagano (JP); Hideki Matsuo, Nagano (JP); Hideaki Matsuyama, kanagawa (JP)

Correspondence Address: Thomas R. Morrison, Esq., MORRISON LAW FIRM, 145 North Fifth Avenue, Mount Vernon, NY, 10550, US

(21) Appl. No.: 09/758,015

(22) Filed: Jan. 10, 2001

(30) Foreign Application Priority Data
Jan. 13, 2000 (JP) 2000-004919
May 10, 2000 (JP) 2000-137762

(51) Int. Cl. G11B 5/72

(52) U.S. Cl. 428/694 TC

(57) ABSTRACT

A carbon protective film of a magnetic recording medium includes a surface region having a high nitrogen concentration. The nitrogen-doped surface region enhances surface energy and improves wettability of the protective film with a liquid lubricant. The nitrogen is implanted by plasma treatment to produce a surface region in the protective film that includes from 6 to 20 at % of nitrogen in the surface region within 30 Å from the film surface. The treatment reduces the contact angle of the film surface with water to the range from of 10 to 30 degrees.

### BACKGROUND

The present invention relates to a magnetic recording medium including a magnetic film, used in a hard disc drive (abbreviated to HDD) that is the main stream of external recording media of a computer. In particular, the invention relates to a magnetic recording medium comprising a carbon protective film that protects the magnetic film constituting a recording layer against mechanical shock by a read-write head and corrosion by external corrosive substances. The invention also comprises a liquid lubricant layer laminated on the protective film.

More specifically, the invention relates to a method for improving wettability of the carbon protective film of such a magnetic recording medium and to a magnetic recording medium, in which high reliability is achieved by means of provision of a protective film with improved wettability.

### BACKGROUND ART

Currently, a real recording density of a magnetic recording medium (also referred to as a ‘disk’) of a HDD has reached 20 Gbits/in² in the development stage and is increasing at the rate of 60% a year. The increase in recording density means that, to read out from a very small region with a high SN ratio, requires a narrower distance between a read-write head and the magnetic film of the recording disk. A flying height, the spacing between the head and the surface of the disk, for a disk of 20 Gbits/in² is 19 nm or less at present. For a disk of 50 Gbits/in², it is estimated that the flying height must decrease to 15 nm or less. Corresponding to the continuing increase in recording density, further decreases in the flying height distance between the head and the magnetic film will also be demanded in the future. Therefore, a protective film on the disk must become thinner. Efforts for obtaining a thinner protective film have conventionally turned to coating the protective film using a sputtering method.

Although the sputtering method allows the formation of a protective film with durability and corrosion-resistance, a film thickness of 80 Å or less is barely attainable. As a next generation process for depositing a carbon protective film to replace the sputtering process, a method of plasma CVD is receiving broad interest and is being actively studied.

However, a carbon protective film formed with the CVD method has small surface energy and poor wettability. Therefore, when lubricant is applied on the protective film for forming a liquid lubricant layer, the lubricant forms droplets. Some of the droplets may be transferred to the head to cause head flight instability. In a GHT (glide height test), a type of reliability test, in particular, the instability of head flight raises a problem of decreased yield of non-defective units.

### OBJECTS AND SUMMARY OF THE INVENTION

In view of the foregoing, it is an object of the present invention to provide a method for improving wettability of a carbon protective film having reduced thickness.

It is another object of the invention to provide a magnetic recording medium that stabilizes head flight and exhibits excellent reliability by provision of a protective film with improved wettability.

To attain the above objects, the inventors of the present invention have made numerous studies and have found that a protective film having the surface thereof exhibiting a certain range of contact angle with water provides excellent wettability with the lubricant. The improved wettability prevents the formation of droplets. The inventors also have found that improved wettability on a protective film surface is accomplished by doping the surface region of the film with high-density nitrogen.

The present invention is made on the basis of the findings, and a magnetic recording medium of the first aspect of the invention comprises a non-magnetic substrate, a magnetic film, a carbon protective film, and a liquid lubricant layer, wherein the protective film has a surface exhibiting a contact angle with water of from 10 to 30 degrees, more preferably, from 12 to 25 degrees.

A magnetic recording medium of the second aspect of the invention comprises a non-magnetic substrate, a magnetic film, a carbon protective film, and a liquid lubricant layer, wherein the protective film comprises a nitrogen-containing layer with nitrogen concentration of 6 to 20 at %, more preferably 9 to 18 at %, in the surface region within 30 Å from the surface of the film.

A method in the third aspect of the invention for improving wettability of a protective film of a magnetic recording medium that includes a magnetic film, a carbon protective film and a liquid lubricant layer sequentially laminated on a non-magnetic substrate, comprises a step for forming a nitrogen-containing layer with nitrogen concentration of 6 to 20 at % in the surface region within 30 Å from the surface of the protective film.

A method in the fourth aspect of the invention for improving wettability of a protective film of a magnetic recording medium that includes a magnetic film, a carbon protective film and a liquid lubricant layer sequentially laminated on a non-magnetic substrate, comprises a step of forming a nitrogen-containing layer in a surface region within 30 Å of the surface of the protective film so that a contact angle of the protective film with water is controlled to be from 10 to 30 degrees.

In the third and fourth aspect of the invention, the nitrogen-containing layer with high nitrogen concentration in the surface region of the protective film is preferably formed by nitrogen plasma treatment.

A magnetic recording medium of the invention comprises a magnetic film, a carbon protective film, and a liquid lubricant layer sequentially laminated on a non-magnetic substrate.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a schematic cross-sectional view showing an example of a magnetic recording medium of the invention.

FIG. 2 is a schematic cross-sectional view showing an example of a conventional magnetic recording medium.

FIG. 3 is a schematic diagram to which reference will be made in describing the principle of filament type ion beam-CVD.

FIG. 4 is a graph showing time variation of the contact angle with water for protective films of Example 1 and Comparative Example 1 as functions of elapsed time after the end of nitrogen plasma treatment.

FIG. 5 is a schematic diagram showing a principle of hollow cathode type ion beam-CVD.

FIG. 6 is a graph showing the time variation of the contact angle with water for protective films of Example 2 and Comparative Example 1 as functions of elapsed time after the end of nitrogen plasma treatment.

FIG. 7 is a chart showing the ranges of nitrogen concentration which give acceptable performance in a durability test using CSS and in a reliability test using GHT.

FIG. 8 is a graph showing a relationship between nitrogen concentration in the surface region of a protective film and the stabilized contact angle with water.

### DETAILED DESCRIPTION OF THE PREFERRED EMBODIMENT

A non-magnetic substrate used in the present invention may be any commonly used non-magnetic substrate including substrates of aluminum alloy, glass, and plastics. Specific material for the plastic substrate may be selected from polycarbonate, polyolefin, poly(ethylene terephthalate), poly(ethylene naphthalate) and polyimide, for example.

The substrate may be a disk substrate of any size including 2.5 inches, 3 inches, 3.3 inches, 3.5 inches and 5 inches. These sizes are nominal sizes and should be understood to include actual sizes commonly now employed in the art, or which may be employed in the future. The shape of the substrate is not limited to a disk, but may be a card, a strip or any other shape.

A magnetic film of the invention includes a ferromagnetic alloy applicable to a recording layer, for example, CoCrTaPt, CoCrTaPt—Cr₂O₃, CoCrTaPt—SiO₂, CoCrTaPt—ZrO₂, CoCrTaPt—TiO₂, and CoCrTaPt—Al₂O₃.

The thickness of the magnetic film is not more than 20 nm , preferably from 10 to 20 nm. A plurality of magnetic films may be employed to construct a recording layer of a multi-layer structure.

A protective film protects the magnetic film forming a recording layer against mechanical shock by a head and corrosion by external corrosive substances. The thickness of the protective film is not more than 8 nm , preferably from 3 to 8 nm.

The protective film may be formed by laminating DLC (diamond-like carbon) by a plasma CVD method. In the CVD method, a thin film is formed at relatively low temperature by decomposing raw material gas with electromagnetic energy and electrons, not with thermal energy. Actually, the thin film is formed by equipment that combines a discharging device with CVD in which a layer is formed by vapor phase deposition. A specific plasma CVD method for laminating a protective film may be selected from filament type ion beam-CVD, electron cyclotron resonance-CVD, radio frequency-CVD, hollow cathode type ion beam-CVD, and electron beam-excited plasma-CVD, for example.

The raw material gas used for laminating a DLC layer may be a hydrocarbon gas, for example, methane (CH₄), ethylene (C₂H₄), acetylene (C₂H₂), or toluene (C₇H₈). Parameters in the plasma CVD can be selected by the person skilled in the art to adjust the deposited layer to the desired thickness of the DLC.

The inventors have studied wettability of a protective film with lubricant and found that a surface of a protective film having a certain range of surface energy exhibits excellent wettability. The inventors have also found that a contact angle of a surface of a protective film with water can be an indicator of the surface energy of the protective film.

The contact angle is the angle of a surface of a water drop with reference to a surface of a protective film when a predetermined quantity of water is dropped on the surface of the protective film specimen while the protective film specimen is held in a horizontal position.

The contact angle of the protective film with water in the invention is in the range from 10 to 30 degrees, more preferably, from 12 to 25 degrees. When the contact angle is greater than 30 degrees, droplets of liquid lubricant are generated. When the contact angle is less than 10 degrees, the lubricant is liable to flow out of the film surface, thereby causing difficulty in application of the lubricant to the film surface.

A protective film having such favorable surface energy is obtained by providing a nitrogen-containing layer with a nitrogen concentration of 6 to 20 at % in the surface region of the film within 30 Å of the surface. More preferably, the nitrogen concentration of the nitrogen-containing layer is in the range of from 9 to 18 at %.

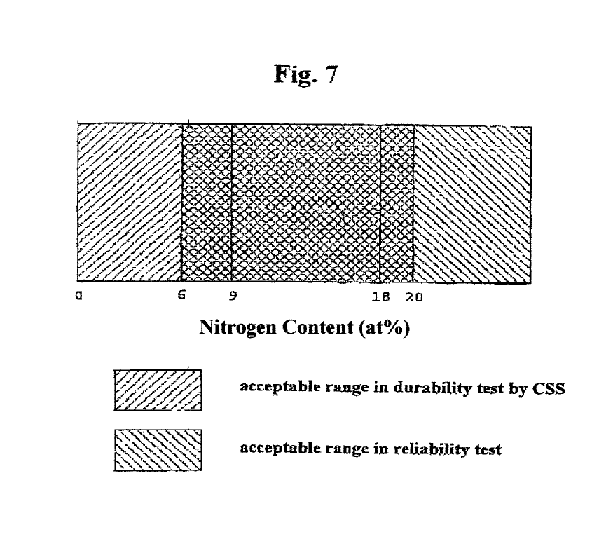

A nitrogen concentration of less than 6 at % causes unstable flight of the head in the GHT. A nitrogen concentration greater than 20 at % tends to adversely affect the durability of the protective film. FIG. 7 shows the ranges of nitrogen concentration that give acceptable performance in a durability test during CSS (contact start and stop) testing and in reliability testing using GHT.

A protective film containing nitrogen in the surface region with high nitrogen concentration is practically obtained by nitrogen plasma treatment. Parameters of the nitrogen plasma treatment are appropriately selected so that the surface region of the protective film within 30 Å from the surface of the film contains nitrogen in an amount of from 6 to 20 at % and, more preferably, from 9 to 18 at %.

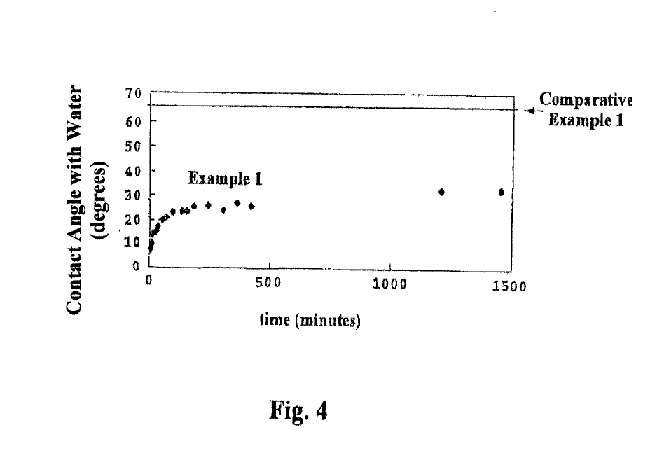

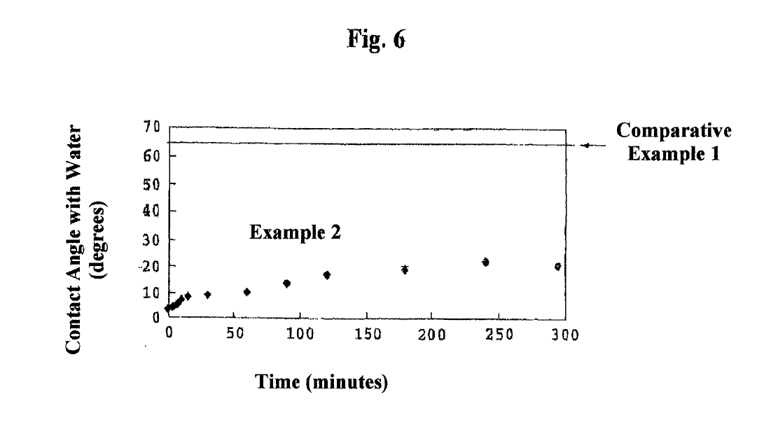

When the surface region of a carbon protective film undergoes a nitrogen plasma treatment that produces a nitrogen concentration of 6 at % in the region within 30 Å from the surface of the film, the protective film is obtained. The surface of the protective film exhibits a stabilized contact angle of about 30 degrees with water. When the surface region undergoes nitrogen plasma treatment that produces a nitrogen concentration of 20 at %, the film surface exhibits a stabilized contact angle of about 10 degrees. Here, “stabilized” precedes the “contact angle” because the contact angle between the film surface and the water varies with time elapsed after the nitrogen plasma treatment until the angle saturates to a stable value, as described later with reference to FIG. 4 and FIG. 6.

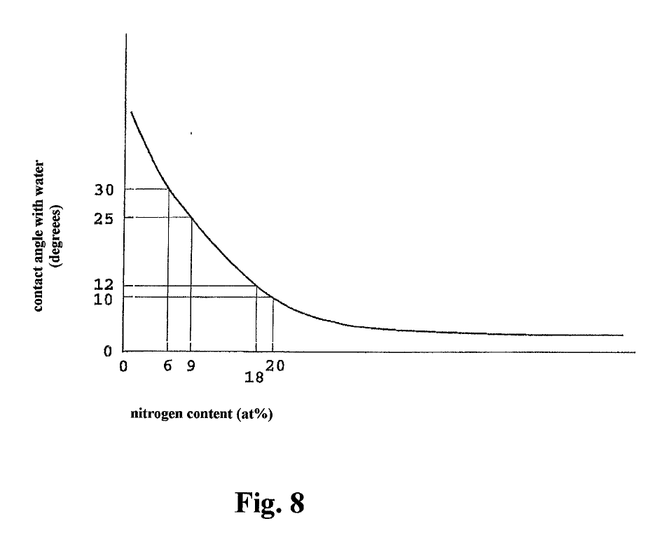

FIG. 8 shows a relationship between the nitrogen concentration in the surface region of the protective film and the stabilized contact angle with water.

As an alternative to nitrogen plasma treatment, a nitrogen-containing layer with high nitrogen concentration in the surface region of the protective film may also be formed by ion-implantation or by nitrogen doping in the step of depositing the DLC layer.

The protective film may be constructed with a plurality of DLC layers with the outermost region within 30 Å from the outermost surface containing nitrogen.

A lubricant layer is provided on the protective film within a predetermined period of time after the formation of the protective film. The lubricant layer is formed by coating with liquid lubricant. The material of the liquid lubricant may be a type of perfluoropolyethers, among which Z-dol (a trade name from Ausimont S.p.A.) is preferred.

A magnetic recording medium of the invention includes a magnetic film, a carbon protective film and a liquid lubricant layer successively laminated. The magnetic recording medium may further comprise other functional layers between the non-magnetic substrate and the magnetic film if necessary. An under-layer is generally provided on the substrate. When the non-magnetic substrate is made of a plastic material, a seed-layer and an under-layer may be sequentially laminated, or alternatively, a buffer-layer, a seed-layer and an under-layer may be sequentially laminated.

The seed-layer can improve flatness of the surface of a magnetic recording medium and can also enhance coercive force. The seed-layer performing such functions may be formed with an alloy film containing titanium as its main component.

The under-layer may be formed of any material commonly used for a conventional under-layer. Specific material for the under-layer may be selected from Cr, Cr—W, Cr—V, Cr—Mo, Cr—Si, Ni—Al, Co₆₇Cr₃₃, Mo, W, and Pt, for example.

A buffer-layer can mitigate damages caused by collision of particles of the seed-layer material in the process of laminating the seed-layer and can absorb thermal stress due to differences in thermal expansion between the plastic substrate and the seed-layer during heating and cooling.

### EXAMPLES

While the present invention is described in detail with reference to specific examples of the embodiments of the invention in the followings, the invention is not limited to the examples.

### Example 1

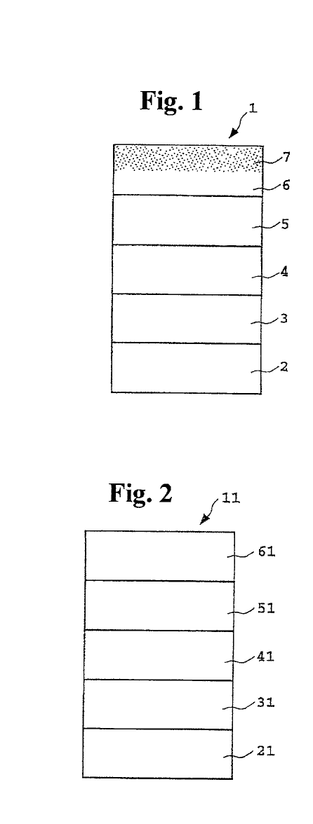

Referring to FIG. 1, a Ni—P plating layer 3 was plated on an aluminum alloy substrate 2. A chromium under-layer 4 of 20 nm thickness and a cobalt magnetic film 5 of 20 nm thickness were sequentially laminated on the Ni—P plating layer by sputtering. Then, a film of DLC 6 was laminated on the cobalt magnetic film 5 using ethylene (C₂H₄) as a raw material gas by means of filament type ion beam-Patent CVD as described in detail below.

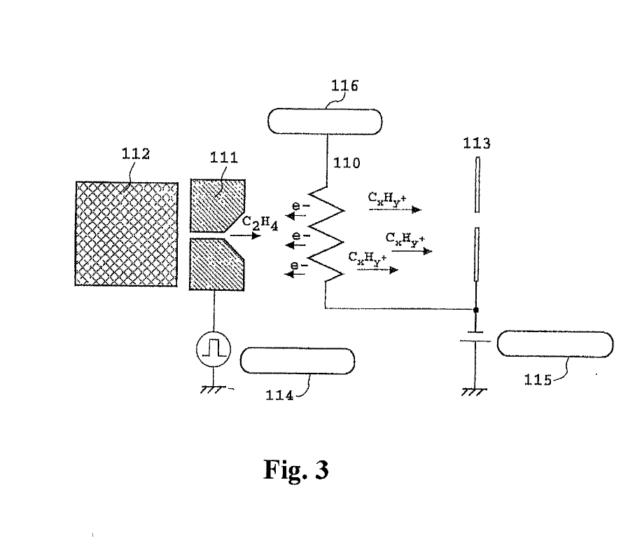

Referring now to FIG. 3 filament type ion beam-CVD employs a. The apparatus is provided with a filament 110 positioned before an anode electrode 111. A magnet 112 is disposed on the opposite side of the anode electrode 111. A substrate 113 is disposed facing the side of the filament 110 remote from the electrode 111. Thermoelectrons emitted by the filament 110 are attracted toward anode electrode 111 by the positive anode voltage. The thermoelectrons collide with gas (raw material gas, C₂H₄) introduced through an opening in the anode electrode 111 toward the filament 111. The collision of the thermoelectrons with the gas generates a plasma. The magnet 112 prolongs the flight path length of the electrons to enhance the collision frequency with the gas. The ions in the plasma are repelled by the anode voltage and in addition, are attracted toward the substrate 113 by the negative bias voltage applied to the substrate 113.

After lamination of the film of DLC, the film was subjected to nitrogen plasma treatment using nitrogen gas to produce a surface region 7 (FIG. 1 ) in the film 6 within 30 Å of the surface containing 9 at % of nitrogen. Thus, a protective film of 8 nm thickness was formed including a nitrogen-containing layer with high nitrogen concentration in the surface region 7 of the film 6. Contact angles of the surface of the protective film with a drop of water varied with time elapsed after the end of the nitrogen plasma treatment, and arrived at a stabilized value of about 25 degrees, as shown in FIG. 4.

Finally, the protective film 6 was coated with Z-dol (a trade name from Ausimont S.p.A.) to form a liquid lubricant layer having a thickness of 2 nm. Thus, the magnetic recording medium of Example 1 was fabricated. GHTs were conducted on the samples of the magnetic recording media fabricated by the process as described above. The head flight of each of the samples was stable and the yield of non-defective units was about 80%.

### Example 2

Still referring to FIG. 1, in a manner similar to Example 1, a Ni—P plating layer 3 was applied to an aluminum alloy substrate 2. Sequentially laminated on the plating layer 3 by sputtering were a chromium under-layer 4 of 20 nm thickness and a cobalt magnetic film 5 of 20 nm thickness. Then, a film of DLC 6 was laminated on the magnetic film 5 using ethylene (C₂H₄) as a raw material gas by means of hollow cathode type ion beam-CVD, in place of filament type ion beam-CVD employed in Example 1. The ion beam-CVD technique is described below.

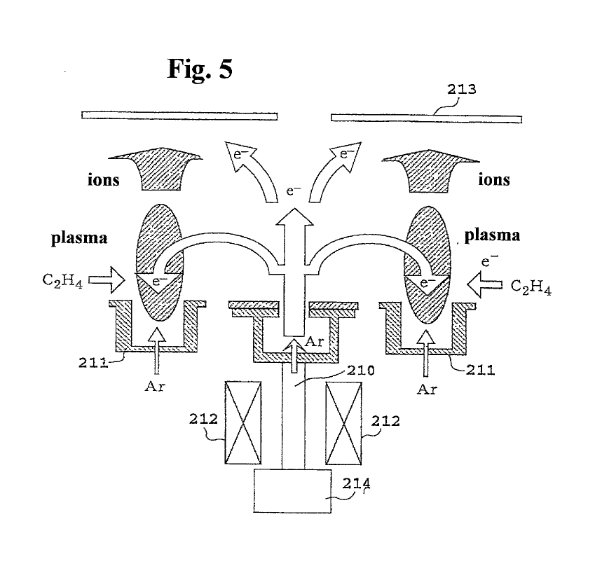

Referring now to FIG. 5, hollow cathode type ion beam-CVD employs a hollow cathode 210 surrounded by an annular anode electrode 211. An annular magnet 212 surrounds the lower part of the hollow cathode 210. Thermoelectrons emitted from the hollow cathode 210 are attracted toward anode electrode 211 by a positive anode voltage. The thermoelectrons collide with Ar gas introduced from the anode side to ionize the Ar, thereby generating Ar⁺ ions. The Ar⁺ ions are repelled by the anode voltage so that they collide with the raw material gas (C₂H₄) to generate plasma. The magnet 212 controls the plasma density. Ions in the plasma originating in the raw material gas are also repelled by the anode voltage toward a substrate 213.

After lamination of the film of DLC 6, the film of DLC 6 was subjected to nitrogen plasma treatment using nitrogen gas to produce a surface region 7 of the film 6 within 30 Å from the surface containing 18 at % of nitrogen. Thus, a protective film of 8 nm thickness was formed including a nitrogen-containing layer with high nitrogen concentration in the surface region 7 of the film of DLC 6.

Referring to FIG. 6 the contact angle of the surface of the protective film of example 2 with a drop of water varied with time elapsed after the end of the nitrogen plasma treatment until it arrived at a value of about 12 degrees. After the initial increase in contact angle, the contact angle increased slowly to a stabilized value below 30 degrees after about 5 hours.

Finally, the protective film was coated with Z-dol (a trade name from Ausimont S.p.A.) to form a liquid lubricant layer having thickness of 2 nm. Thus, the magnetic recording medium of Example 2 was fabricated.

GHTs were conducted on the samples of the magnetic recording media fabricated by the process as described above. The head flight of each of the examples was stable and the rate of non-defective units was about 80%.

### Comparative Example 1

Referring to FIG. 2, a conventional magnetic recording medium has the same structure as the magnetic recording medium of examples 1 and 2 except for the omission of the high-nitrogen surface region 7. A Ni—P plating layer 31 was plated on an aluminum alloy substrate 21. A chromium under-layer 41 and cobalt magnetic film 51 were sequentially laminated on the Ni—P plating layer 31 by sputtering. Then, a protective film of DLC 61 was laminated on the magnetic film 51 by means of plasma-CVD. The contact angle of the protective film 61 with a drop of water was about 65 degrees.

Then, a liquid lubricant layer was formed by coating the protective film 61 with Z-dol (a trade name from Ausimont S.p.A.).

GHTs were conducted on the comparative examples of the magnetic recording media fabricated by the process described above. The head flight of each of the samples was unstable and the rate of non-defective units was nearly 0%.

A carbon protective film of a magnetic recording medium according to the invention comprises a nitrogen-containing layer with high nitrogen concentration in the surface region of the film. The surface of the protective film exhibits increased surface energy and improved wettability with a liquid lubricant. A magnetic recording medium provided with such a protective film prevents formation of droplets of the lubricant, which is liable to transfer to a head, and accordingly, assures stable head flight. Therefore, the present invention provides a highly reliable magnetic recording medium that meets the demand for enhanced density of magnetic recording.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A magnetic recording medium comprising:
a non-magnetic substrate;
a magnetic film laminated on said substrate;
a carbon protective film on said magnetic film;
a contact angle of a surface of said protective film with water is in a range from 10 to 30 degrees; and
a liquid lubricant layer on said carbon protective film;.

2. A magnetic recording medium according to claim 1, wherein said contact angle is in a range from 12 to 25 degrees.

3. A magnetic recording medium comprising:
a non-magnetic substrate;
a magnetic film laminated on said substrate;
a carbon protective film on said magnetic film;
said protective film includes a nitrogen-containing layer having a nitrogen concentration of from 6 to 20 at % in a surface region of said protective film within 30 Å from a surface of said protective film; and
a liquid lubricant layer on said carbon protective film.

4. A magnetic recording medium according to claim 3, wherein said nitrogen concentration is from 9 to 18 at %.

5. A method for improving wettability of a carbon protective film of a magnetic recording medium of a type having a magnetic film, said protective film, and a liquid lubricant layer successively laminated on a non-magnetic substrate, comprising forming a nitrogen-containing layer with a nitrogen concentration of 6 to 20 at % in a surface region of said protective film within 30 Å from a surface of said protective film.

6. A method for improving wettability of a carbon protective film of a magnetic recording medium according to claim 5, wherein the step of forming said nitrogen-containing layer includes forming said nitrogen-containing layer using a nitrogen plasma treatment, and forming said lubricant layer within about 300 minutes of the step of forming said nitrogen-containing layer.

7. A method for improving wettability of a carbon protective film of a magnetic recording medium having a magnetic film, said protective film, and a liquid lubricant layer being successively laminated on a non-magnetic substrate, comprising:
forming a nitrogen-containing layer in a surface region of said protective film within 30 Å from a surface of said protective film; and
controlling said forming to produce a contact angle of a surface of said protective film with water in the range from 10 to 30 degrees.

8. A method for improving wettability of a carbon protective film of a magnetic recording medium according to claim 7, wherein said step for forming said nitrogen-containing layer employs a nitrogen plasma treatment.

9. A protective film for a magnetic recording medium comprising:
a surface region of said protective film; and
said surface region including an amount of nitrogen exceeding about 10 at %.

10. A method of forming a protective film on a magnetic recording medium comprising:
depositing said protective film on said magnetic recording medium;
doping a surface region of said protective film with a concentration of nitrogen exceeding about 10 at %; and
controlling said doping so that said surface region extends about 30 Å from a surface of said protective film.

11. A method according to claim 10, wherein said concentration is from about 10 to about 30 at %.

12. A method of forming a protective film on a magnetic recording medium comprising:
depositing said protective film on said magnetic recording medium;
doping a surface region of said protective film with a concentration of nitrogen sufficient to produce a contact angle of a surface of said protective film with water exceeding about 10 degrees.

13. A method according to claim 12, wherein the step of doping includes doping with nitrogen sufficient to produce a contact angle of a surface of said protective film with water of from about 10 to 30 degrees within a predetermined time after the step of doping.

14. A method according to claim 12, further comprising depositing a lubricant layer on said protective film at a time that a contact angle of a surface of said protective film with water is less than 30 degrees.

15. A method according to claim 14, wherein said time is less than 300 minutes.
